(19) United States
(12) Patent Application Publication
(10) Pub. No.: US 2025/0367924 A1
(43) Pub. Date: Dec. 4, 2025

(54) INKJET RECORDING APPARATUS AND RECORDING POSITION ADJUSTMENT METHOD

(71) Applicant: CANON KABUSHIKI KAISHA, Tokyo (JP)

(72) Inventors: TAKUMI OTANI, Kanagawa (JP); NAOKO BABA, Kanagawa (JP); HIROSHI KAWAFUJI, Tokyo (JP); YUKI MORITA, Tokyo (JP); RYOSUKE HIROKAWA, Meerbusch (DE); AKIHIRO MOURI, Tokyo (JP)

(21) Appl. No.: 19/218,045

(22) Filed: May 23, 2025

(30) Foreign Application Priority Data
May 28, 2024 (JP) 2024-086657

(51) Int. Cl. B41J 2/045

(52) U.S. Cl. CPC B41J 2/04573; B41J 2/04505; B41J 2/04508; B41J 2/04536; B41J 2/04556; B41J 2/0458

(57) ABSTRACT

An inkjet recording apparatus includes a recording head, a carriage, a first adjustment unit, a data storage unit, and a first correction value calculation unit, wherein the first adjustment unit adjusts the ejection timings at n scanning speeds in a case where the first adjustment unit adjusts the ejection timings with the adjustment values unstored in the data storage unit, the first adjustment unit adjusts the ejection timings at n-1 or fewer scanning speeds in a case where the first adjustment unit adjusts the ejection timings with the adjustment values stored in the data storage unit, and the first correction value calculation unit uses the correction value calculated based on the adjustment value from the first adjustment unit for an adjustment value at a scanning speed at which an ejection timing is not adjusted.

### BACKGROUND

### Field of the Disclosure

The present disclosure relates to an inkjet recording apparatus and a recording position adjustment method.

### Description of the Related Art

In an inkjet recording apparatuses, misalignment of dot recording positions may occur during recording in both directions of reciprocating scanning. This misalignment of dot recording positions can lead to decrease in recording quality, and there are known techniques for correcting such misalignment.

U.S. Pat. No. 6,092,939 discusses a method of recording a plurality of sample patterns (hereinafter, also referred to as adjustment patterns) by shifting ink ejection timings of the backward scans relative to the forward scans, which serve as a reference. A sensor mounted on a carriage of the inkjet recording apparatus scans a recorded medium to optically read the adjustment patterns, and determines the adjustment values.

Some inkjet recording apparatuses are capable of setting a plurality of modes with different levels of quality and printing speed.

US Patent Application Publication No. 2002/0030708 discusses a method of recording a plurality of adjustment patterns at different scanning speeds, calculating an ink ejection speed from a selected predetermined adjustment pattern and a distance from the head surface of the recording head to the recording surface of the recording medium, storing this calculated ink ejection speed in non-volatile memory, and correcting the misalignment of dot recording positions based on the scanning speed of the recording head and the stored ink ejection speed during a recording operation.

### SUMMARY

According to embodiments of the present disclosure, an inkjet recording apparatus includes a recording head including a plurality of nozzle arrays for ejecting ink, a carriage configured to cause the recording head to perform scanning at least at two or more speeds, a first adjustment unit configured to adjust an ejection timing of the ink from the recording head with reference to each of the scanning speeds of the carriage, a data storage unit configured to store the adjusted ejection timings as adjustment values, and a first correction value calculation unit configured to calculate a correction value with respect to each of the scanning speeds of the carriage using the adjustment values stored in the data storage unit, wherein the first adjustment unit adjusts the ejection timings at n scanning speeds in a case where the first adjustment unit adjusts the ejection timings with the adjustment values unstored in the data storage unit, the first adjustment unit adjusts the ejection timings at n-1 or fewer scanning speeds in a case where the first adjustment unit adjusts the ejection timings with the adjustment values stored in the data storage unit, and the first correction value calculation unit uses the correction value calculated based on the adjustment value from the first adjustment unit for an adjustment value at a scanning speed at which an ejection timing is not adjusted.

Further features of the present disclosure will become apparent from the following description of exemplary embodiments with reference to the attached drawings.

### BRIEF DESCRIPTION OF THE DRAWINGS

FIG. 1 is a perspective view of an example of an external appearance configuration of a recording apparatus according to a first exemplary embodiment.

FIG. 2 is a diagram illustrating an example of a schematic configuration of an optical sensor illustrated in FIG. 1.

FIG. 3 is a diagram illustrating an example of an arrangement configuration of ejection nozzles in a recording head illustrated in FIG. 1.

FIG. 4 is a diagram illustrating an example of a functional configuration of the recording apparatus illustrated in FIG. 1.

FIG. 5 is an enlarged diagram illustrating a configuration of registration adjustment patterns when a concentration detection is performed by the optical sensor.

FIG. 6 is an overall view of a configuration of a registration adjustment pattern group when the concentration detection is performed by the optical sensor.

FIG. 7 is a graph illustrating densities detected from registration adjustment patterns and an approximation curve.

FIG. 8 is a diagram illustrating misalignments of dot recording positions with a change in an ink ejection speed.

FIG. 9 is a diagram illustrating a method for adjusting a misalignment of dot recording positions without recording on a recording medium.

FIG. 10 is a table illustrating registration adjustment values determined in a first registration adjustment process according to the first exemplary embodiment.

FIG. 11 is a table illustrating registration adjustment values determined in a second registration adjustment process according to the first exemplary embodiment.

FIGS. 12A to 12D are graphs representing comparisons between the first adjustment values and the second adjustment values according to the first exemplary embodiment.

FIGS. 13A to 13D are graphs representing comparisons between registration adjustment values before and after a replacement of a recording head according to a fourth exemplary embodiment.

FIG. 14 is a flowchart illustrating an example of a procedure of processing in the recording apparatus according to the first exemplary embodiment.

FIGS. 15A to 15D are tables illustrating registration adjustment values and registration correction values according to the first exemplary embodiment.

FIG. 16 is a flowchart illustrating an example of a procedure of processing in the recording apparatus according to a second exemplary embodiment.

FIGS. 17A to 17D are tables illustrating registration adjustment values and registration correction values according to the second exemplary embodiment.

FIGS. 18A to 18E are tables illustrating registration adjustment values and registration correction values according to the second exemplary embodiment.

FIG. 19 is a flow chart illustrating an example of a procedure of processing in the recording apparatus according to a third exemplary embodiment.

FIGS. 20A to 20F are tables illustrating registration adjustment values and registration correction values according to the third exemplary embodiment.

FIG. 21 is a graph illustrating a relationship between a distance from a head surface of the recording head to the recording surface of the recording medium and a registration adjustment value according to the third exemplary embodiment.

FIG. 22 is a flowchart illustrating an example of a procedure of processing in the recording apparatus according to the fourth exemplary embodiment.

FIG. 23 is a flowchart illustrating an example of a procedure of processing in the recording apparatus according to a fifth exemplary embodiment.

### DESCRIPTION OF THE EMBODIMENTS

In the method discussed in US Patent Application Publication No. 2002/0030708, to improve the adjustment accuracy for variations in the distance from the head surface of the recording head to the recording surface of the recording medium (hereinafter, also referred to as a recording head-recording medium distance) and for misalignment of dot recording positions due to various scanning speeds of the recording head, the number of adjustment patterns to be recorded is increased. This results in a longer processing time for adjusting the dot recording positions (hereinafter, also referred to as registration adjustment processing), and increases in the amounts of ink and recording media consumed. In addition, due to changes in the ink ejection speed caused by wear and replacement of the recording head, the above-described registration adjustment processing is to be performed each time, which will significantly reduce the usability.

A first exemplary embodiment will now be described. Hereinafter, exemplary embodiments of the present disclosure will be described in detail with reference to the drawings.

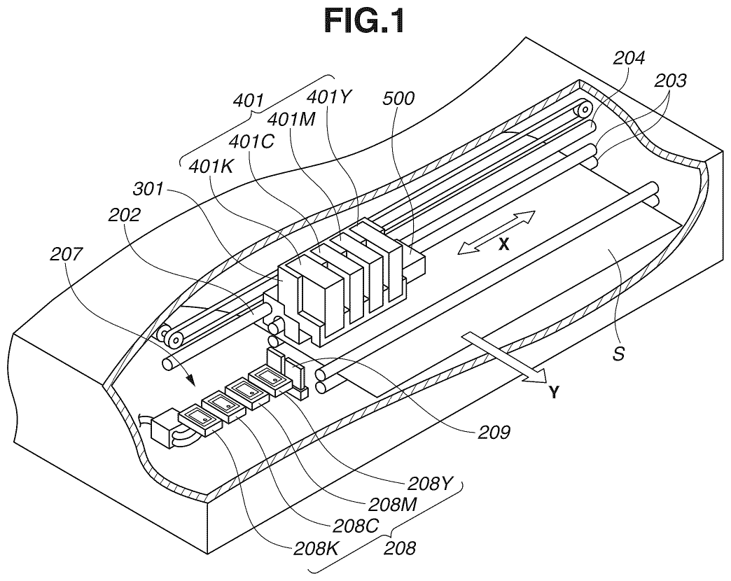

FIG. 1 is a perspective view of an example of an external appearance configuration of an inkjet recording apparatus 1 according to a first exemplary embodiment. The recording apparatus 1 includes an inkjet recording head (hereinafter, referred to as a recording head) 301 mounted on a carriage 202. The recording head 301 ejects ink for recording based on an inkjet method. The recording apparatus 1 moves the carriage 202 back and forth in the directions of arrow X (the main scanning directions) to perform recording. The recording apparatus 1 feeds a recording medium S, such as recording paper, via a paper feed mechanism and conveys the recording medium S in the direction of arrow Y (the sub-scanning direction). The recording apparatus 1 then causes the recording head 301 to eject ink onto the recording medium S at predetermined recording positions to perform recording.

The carriage 202 includes a (reflective) optical sensor 500 and ink cartridges 401, for example. In this case, the carriage 202 includes four ink cartridges 401 (401K, 401C, 401M, 401Y) containing black (K), cyan (C), magenta (M), and yellow (Y) inks, respectively. These four ink cartridges 401 can be attached and detached independently. In the present exemplary embodiment, an on-carriage method is employed in which the ink cartridges 401 of individual ink colors are mounted on the carriage 202. Alternatively, an off-carriage method can be employed in which main tanks for individual ink colors are installed in positions other than the carriage 202 in the inkjet recording apparatus 1, and ink is supplied to the recording head 301 through supply paths, such as tubes.

The recording head 301 includes a plurality of nozzle arrays (ejection ports) for ejecting inks of corresponding colors. In this case, nozzle arrays capable of ejecting black, cyan, magenta and yellow inks are formed corresponding to the ink cartridges 401 described above.

The recording head 301 includes heating resistance elements and ejects ink using thermal energy. The heating resistance elements are provided in the ejection ports. A pulse voltage is applied to the corresponding heating resistance element in response to a recording signal. With this configuration, ink is ejected from a corresponding ejection port. The recording head can use a piezoelectric element to eject ink instead of a heating resistance element.

The recording head 301 is detachably (i.e., replaceably) mounted on the carriage 202. The carriage 202 is slidably supported on a guide rail 204, and is reciprocated along the guide rail 204 by a driving unit (not illustrated), such as a motor. The recording medium S is conveyed in the sub-scanning direction (the arrow Y) by conveyance rollers 203 with a predetermined interval from the ejection port surface (the surface on which ink ejection ports are formed) of the recording head 301.

Outside the range of reciprocating movement of the carriage 202 (outside the recording area), a recovery unit 207 is disposed to address ejection failure of the recording head 301. The position where the recovery unit 207 is provided is called a home position, and the recording head 301 remains stationary at that position while no recording operation is being performed. The recovery unit 207 is provided with caps 208 (208K, 208C, 208M, and 208Y) capable of capping the ejection ports of the recording head 301. The caps 208K, 208C, 208M, and 208Y are capable of capping the ejection ports that eject black, cyan, magenta, and yellow inks, respectively.

The caps 208 each include a suction pump (a negative pressure generation unit) connected inside. When the caps 208 cap the ejection ports of the recording head 301, negative pressure can be applied inside the caps 208, allowing ink to be suctioned and discharged (a suction recovery operation) from the ejection ports of the recording head 301 into the caps 208. This suction recovery operation can maintain the ink ejection performance of the recording head 301.

The recovery unit 207 includes a wiper 209, such as a rubber blade for wiping the ejection port surface of the recording head 301. The recovery unit 207 performs a recovery process (also referred to a preliminary ejection) for maintaining the ink ejection performance of the recording head 301 by discharging ink from the recording head 301 into the caps 208.

The carriage 202 is equipped with the recording head 301 and the ink cartridges 401, as well as a reflective optical sensor (hereinafter, referred to as an optical sensor) 500. The optical sensor 500 acquires optical characteristics, and optically reads registration adjustment patterns (hereinafter, referred to as adjustment patterns) recorded on the recording medium S to measure the recorded densities.

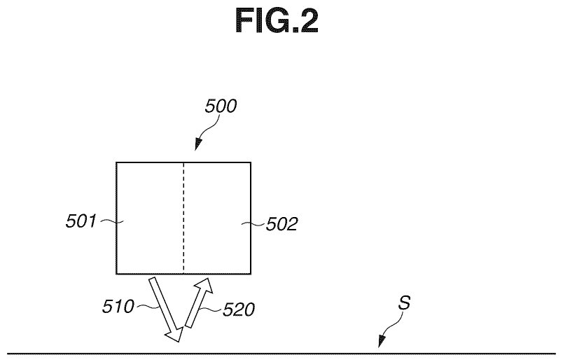

As illustrated in FIG. 2, the optical sensor 500 is provided with a light emitting unit 501 implemented by a light emitting diode (LED), and a light receiving unit 502 implemented by a photodiode. Irradiation light 510 emitted by the light emitting unit 501 is reflected on the recording medium S, and reflected light 520 enters the light receiving unit 502. The light receiving unit 502 converts the reflected light 520 into electrical signals.

In measuring the recorded densities of the adjustment patterns, the conveyance of the recording medium S in the sub-scanning direction and the movement of the carriage 202 with the optical sensor 500 in the main scanning directions are alternately performed. In this manner, the optical sensor 500 detects the densities of an adjustment pattern group recorded on the recording medium as optical reflectance.

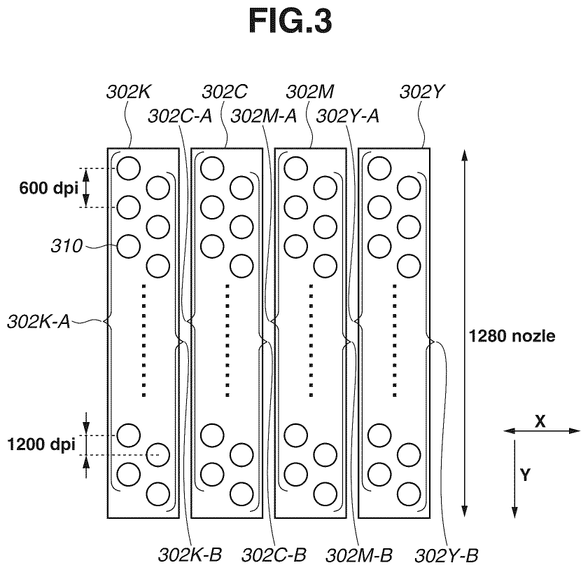

An example of an arrangement configuration of the ejection nozzles 310 in the recording head 301 illustrated in FIG. 1 will be described with reference to FIG. 3.

In the recording head 301, a plurality of nozzle arrays is in a staggered manner in the sub-scanning direction (the nozzle arrangement direction) that intersects (in the present exemplary embodiment, orthogonally) with the main scanning directions. Specifically, the nozzles (302K, 302C, 302M, and 302Y) that eject inks of the corresponding colors (CMYK) are arranged at predetermined intervals along the sub-scanning direction (the Y direction), and the nozzle arrays are arranged along the main scanning directions (the X directions). The nozzle arrays are arranged in pairs (302K-A and 302K-B, 302C-A and 302C-B, 302M-A and 302M-B, and 302Y-A and 302Y-B) corresponding to the ink colors. In each nozzle array, 1280 nozzles are arranged at intervals of 600 dpi (dots per inch). In addition, the nozzle arrays (two nozzle arrays) that eject ink of the same color are arranged in the sub-scanning direction, staggered by 1200 dpi (half-pitch). In other words, for high recording resolution, the nozzle arrays are arranged in staggered positions in the sub-scanning direction. This arrangement method is employed because, while downsizing ink droplets can decrease the size of dots spread on the recording medium to improve the resolution, higher resolution through smaller dot sizes is not easy. In the present exemplary embodiment, the resolution of each nozzle array in the sub-scanning direction is 600 dpi. However, the staggered arrangement positions of the nozzle arrays make it possible to perform recording at a resolution of 1200 dpi in the sub-scanning direction.

In the present exemplary embodiment, a plurality of adjustment patterns each including a first pattern and a second pattern is recorded on a recording medium. At this time, the relative recording positions of the second pattern with respect to the first pattern along the sub-scanning direction are made different.

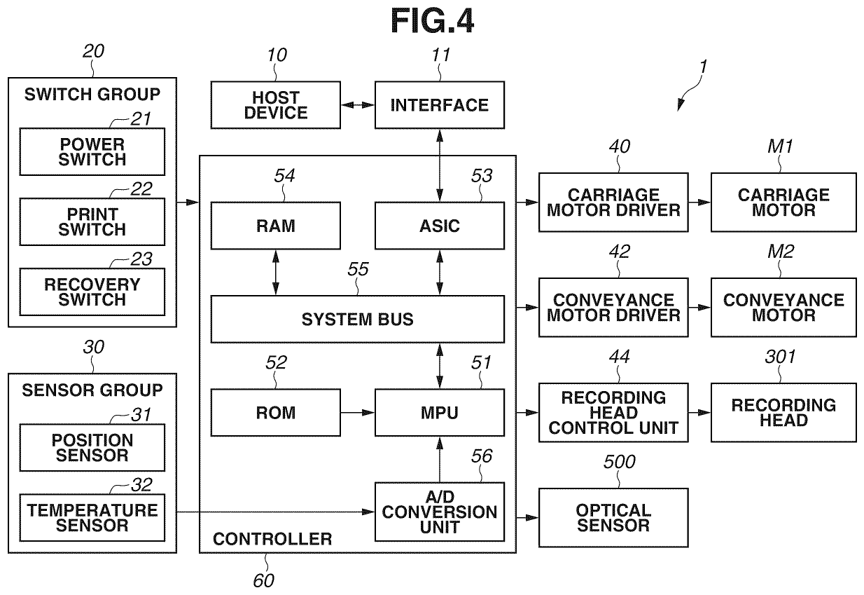

An example of a functional configuration of the recording apparatus 1 illustrated in FIG. 1 will now be described with reference to FIG. 4.

A controller 60 includes a micro processing unit (MPU) 51, a read-only memory (ROM) 52, an Application Specific Integrated Circuit (ASIC) 53, a random-access memory (RAM) 54, a system bus 55, and an analog/digital (A/D) converter 56. The ROM 52 stores programs for control sequences described below, tables to be used, and other fixed data.

The ASIC 53 controls a carriage motor M1 and a conveyance motor M2. The ASIC 53 generates control signals for controlling the recording head 301. The RAM 54 is used as a working area for loading image data and executing programs. The system bus 55 interconnects the MPU 51, the ASIC 53, and the RAM 54 to exchange data. The A/D converter 56 performs A/D conversion on analog signals input from a sensor group (described below) and supplies the converted digital signals to the MPU 51.

The MPU 51 generally controls the operation of the recording apparatus 1. For example, during a registration adjustment process, the MPU 51 calculates registration adjustment values (hereinafter, also referred to as adjustment values) based on measurement results of the adjustment patterns described above. The adjustment values are stored, for example, in the RAM 54. Further, the MPU 51 changes the ejection timings of ink ejected from the nozzles based on the adjustment values stored in the RAM 54, and adjusts the landing positions (adhesion positions) of dots formed on the recording medium.

A switch group 20 includes a power switch 21, a print switch 22, and a recovery switch 23. A sensor group 30 that detects states of the apparatus includes a position sensor 31 and a temperature sensor 32. During scanning of the recording head 301, the ASIC 53 transfers data for driving the recording elements (ejection heaters) to the recording head 301 while directly accessing a storage area of the RAM 54.

A recording head control unit 44 controls the recording operation of the recording head 301 by moving the recording head 301 relatively with respect to the recording medium.

The carriage motor M1 is a drive source for reciprocating scanning of the carriage 202 in predetermined directions, and a carriage motor driver 40 controls the driving of the carriage motor M1. The conveyance motor M2 is a drive source for conveying a recording medium, and a conveyance motor driver 42 controls the driving of the conveyance motor M2. The recording head 301 performs scanning in directions (the main scanning directions) substantially orthogonal to the conveyance direction of the recording medium. The optical sensor 500 detects the density of an adjustment pattern group recorded on the recording medium as optical reflectance.

A host device 10 is a computer (alternatively, an image reader, or a digital camera) that serves as a supply source of image data. Image data, commands, and status signals are exchanged between the host device 10 and the recording apparatus 1 via an interface (hereinafter, referred to as I/F) 11. The above is a description of a configuration example of the recording apparatus 1.

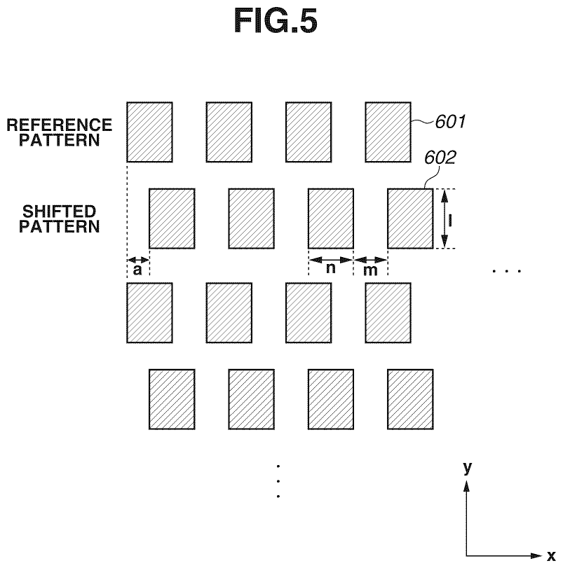

A configuration example of adjustment patterns used in the registration adjustment process will now be described with reference to FIGS. 5 to 7.

As illustrated in FIG. 5, each adjustment pattern is formed such that a rectangular pattern of i pixels×n pixels is periodically repeated every m-pixels blank area, with the main scanning directions as the x directions and the sub-scanning direction as the y direction. A shifted pattern (a second pattern) 602 is recorded with its recording position shifted by a predetermined number of pixels in the sub-scanning direction relative to a reference pattern (a first pattern) 601. The resolution and shift amount of these adjustment patterns are determined based on the recording resolution of the recording apparatus. In the present exemplary embodiment, the recording resolution is 1200 dpi.

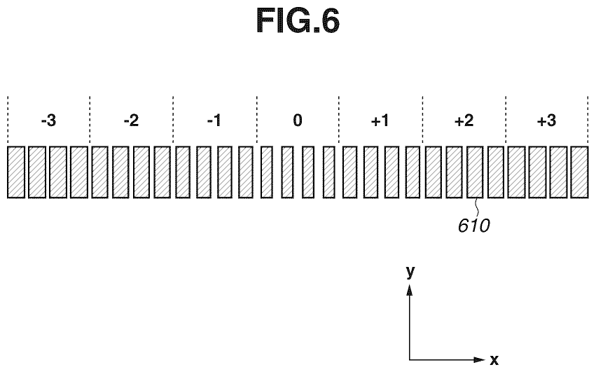

FIG. 6 is an overall view of a configuration in which the plurality of adjustment patterns illustrated in FIG. 5 is arranged, with the main scanning directions as the x directions and the sub-scanning direction as the y direction. In this case, the adjustment pattern group illustrated in FIG. 6 is recorded such that a shift amount a of the shifted pattern (the second pattern) in the sub-scanning direction is changed from −3 pixels to +3 pixels.

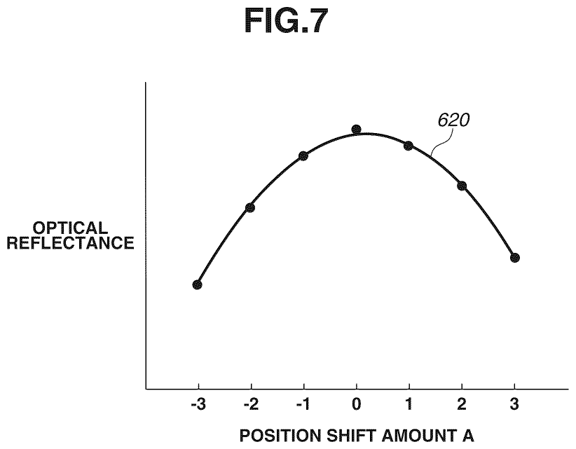

As the shift amount of recording position of the shifted pattern relative to the reference pattern changes, the ink area ratio on the recording medium changes. FIG. 7 illustrates the measurement results of the optical reflectance for each shift amounts illustrated in FIG. 6. The density is inversely proportional to the reflectance. As the positional shift between the adjustment patterns actually recorded on the recording medium is smaller, the density is lower and the optical reflectance is higher.

Thus, to align the recording positions of dots from the nozzle arrays used to form the reference pattern with the recording positions of dots from the nozzle arrays used to form the shifted pattern, the ejection timing is adjusted based on the shift amount with which the density of the adjustment pattern is at its lowest. Thus, the ejection timing of ink from the nozzle arrays used to form the shifted pattern is adjusted.

The number and shift amount of adjustment patterns formed on the recording medium are determined based on the adjustment range involved with the mechanical tolerances of the apparatus and the shift units of the recording positions, i.e., based on the accuracy of the registration adjustment process. The recording area of the adjustment patterns is determined based on the size of the detection area of the optical sensor 500, the width of the area recordable in one recording scan, and the size of the recordable area of the recording medium for the adjustment pattern group.

The nozzle arrays used in formation of the reference pattern and the shifted pattern are determined by the combination of an ink color and a scanning direction of the nozzle arrays to be adjusted. In adjustment for the forward scanning, a reference nozzle array (e.g., 302K-A) is selected to form the reference pattern, and another nozzle array (e.g., 302C-A) is used to form the shifted pattern. The same procedure is applied to the backward scanning.

The position where the ink ejected from each nozzle reaches a recording medium varies depending on various factors, such as a distance between the recording head and the recording medium, an ejection speed for each ink, and the scanning speed of the recording head. Specifically, as the scanning speed of the recording head increases, the variations in ink ejection speed and the recording head-recording medium distance lead to greater misalignment of dot recording positions.

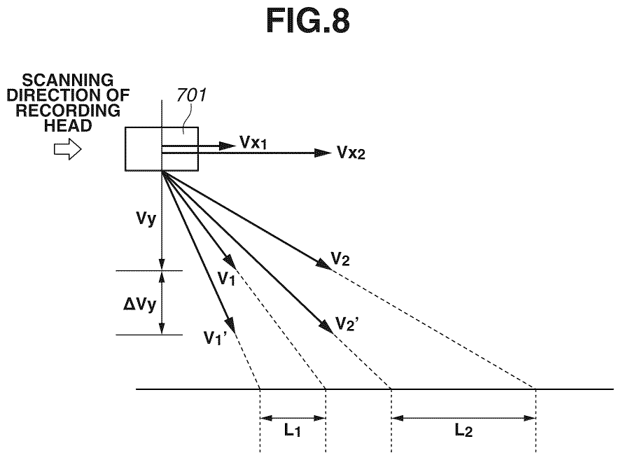

FIG. 8 illustrates misalignment of the dot recording positions when the recording head-recording medium distance varies at two different recording head scanning speeds.

FIG. 8 illustrates a recording head 701, an ink ejection speed Vy, and ink flying speeds V1 and V2 when the recording head is moved at scanning speeds Vx₁ and Vx₂, respectively.

(Vx₁<Vx₂)

When the distance between the recording head and the recording medium changes by ΔH, the misalignment of the dot recording positions at the scanning speed Vx₁ is L1, and the misalignment of the dot recording positions at the scanning speed Vx₂ is L2. As is evident from FIG. 8, when the amounts of change in recording head-recording medium distance are the same, the misalignment of the dot recording positions is greater at the higher scanning speed Vx₂ of the recording head.

FIG. 8 also illustrates misalignment of the dot recording positions when the ink ejection speed varies at two different recording head scanning speeds. The main scanning directions are the x directions, and the sub-scanning direction is the y direction. As in FIG. 8, the drawing illustrates a recording head 701, an ink ejection speed Vy, and ink flying speeds V1 and V2 when the recording head is moved at scanning speeds Vx₁ and Vx₂, respectively.

(Vx₁<Vx₂)

With respect to a change ΔV in the ink ejection speed, the ink flying speed is V₁′ at the scanning speed Vx₁, and the ink flying speed is V₂′ at the scanning speed Vx₂. The misalignments of the dot recording positions are L1 and L2, respectively. As illustrated in FIG. 8, when the amounts of change in ink ejection speed are the same, the misalignment of the dot recording positions is greater at the higher scanning speed Vx₂ of the recording head.

As described above, as the scanning speed of the recording head is higher, the misalignment of the dot recording positions is larger due to the change in recording head-recording medium distance and the ink ejection speed.

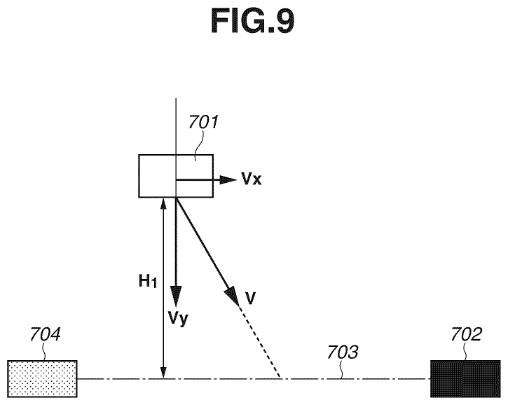

There is a method for predicting dot recording positions and performing the registration adjustment process by using the above-described relationship without recording adjustment patterns on the recording medium. FIG. 9 illustrates details of the method. Referring to FIG. 9, a laser emitting apparatus 702 horizontally emits a laser beam 703 toward a light receiving unit 704. Detecting signal values at the light receiving unit 704 allows determination of the timings when ink droplets ejected from the recording head pass through the laser beam irradiation surface, since the laser light is blocked and the received irradiation intensity decreases. Measuring the time from when the ink droplets are ejected to when they pass through the laser beam irradiation surface makes it possible to predict the ink flying speed together with a known recording head-laser irradiation surface distance H. The dot recording positions at the recording head-recording medium distance during the recording operation can be predicted from the predicted flying speed Vy and a known scanning speed Vx of the recording head. This allows adjustment of the misalignment of the dot recording positions and reflection of the adjusted position without actually recording adjustment patterns on the recording medium.

In conventional inkjet recording apparatuses, the above-described registration adjustment process is performed at a plurality of scanning speeds of the recording head. This provides high adjustment accuracy at each scanning speed. However, when the registration adjustment process is performed regularly or each time the recording head is replaced, issues arise, such as a lengthy adjustment process, high ink consumption, and excessive use of a recording medium.

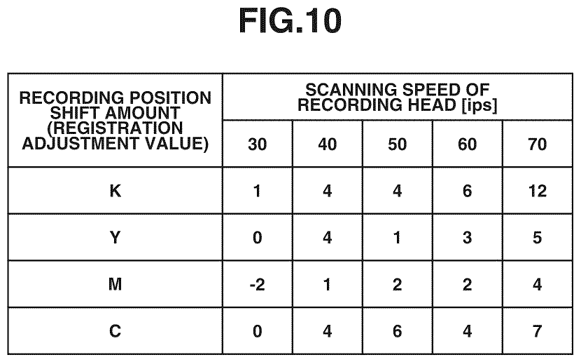

FIG. 10 illustrates a result of first registration adjustment values in the present exemplary embodiment. The registration adjustment process is performed at a plurality of recording head scanning speeds, and recording position shift amounts (hereinafter, also referred to as registration adjustment values) determined based on the adjustment results are stored in the ROM 52. Referring to FIG. 10, the scanning speeds of the recording head are adjusted at 30 to 70 inches per second (ips).

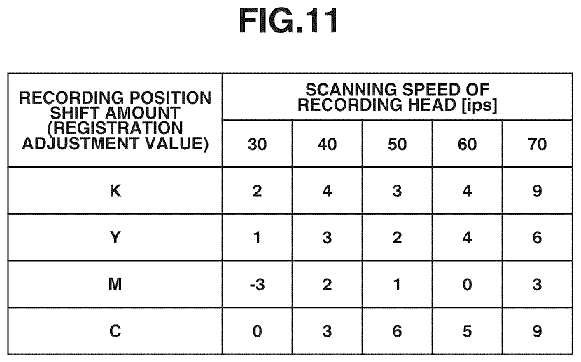

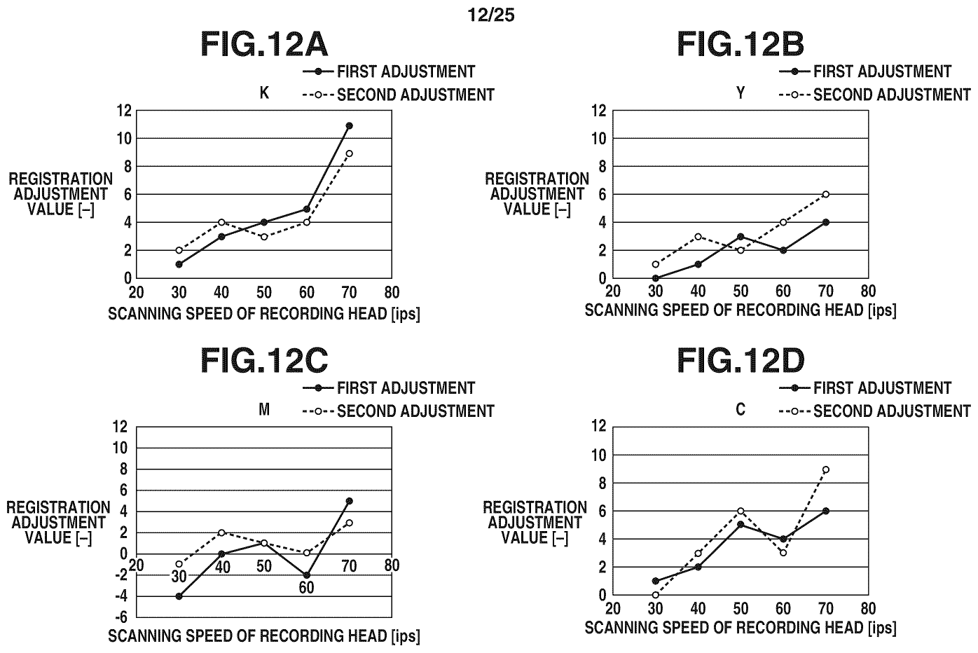

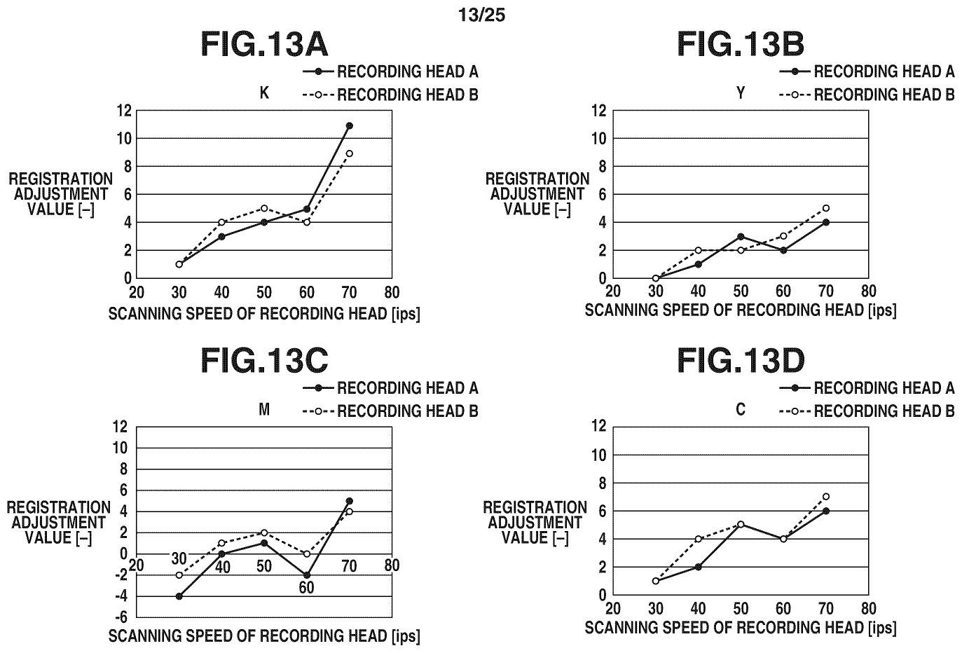

The registration adjustment values illustrated in FIG. 11 are values with which the recording operation has been repeated for a sufficient period of time using the recording head having the registration adjustment values illustrated in FIG. 10, and then the second registration adjustment process is performed using the same recording head. FIGS. 12A to 12D are graphs representing the comparisons between the first registration adjustment values (solid lines) and the second registration adjustment values (dashed lines) from FIGS. 10 and 11, with the recording head scanning speeds on the horizontal axis, and the registration adjustment values on the vertical axis. FIGS. 12A, 12B, 12C, and 12D illustrate the registration adjustment values of inks K, Y, M, and C, respectively. While the absolute values differ for each ink color, the transition of the registration adjustment values with respect to the scanning speed of the recording head is similar between the first and second adjustments. This allows estimation of registration adjustment values at other scanning speeds based on the values at a specific scanning speed. FIGS. 13A to 13D are graphs of each ink color, representing the comparisons between the first registration adjustment values of the recording head (a recording head A) subjected to the registration adjustment processing in FIG. 12A to 12D and the registration adjustment values of another recording head (a recording head B). As in FIGS. 12A to 12D, the transition of the registration adjustment values with respect to the scanning speed of the recording head is similar. Thus, if the absolute value of the registration adjustment value for a certain recording scan is known, the registration adjustment values for the remaining recording scans can be estimated. The use of the registration adjustment values determined and stored in ROM 52 in previous registration adjustment processes makes it possible to maintain high adjustment accuracy without the registration adjustment processing at all scanning speeds as subsequent registration adjustment processes or after replacing the recording head, and reduce the time, and the amounts of ink and media consumed involved in performing the registration adjustment process.

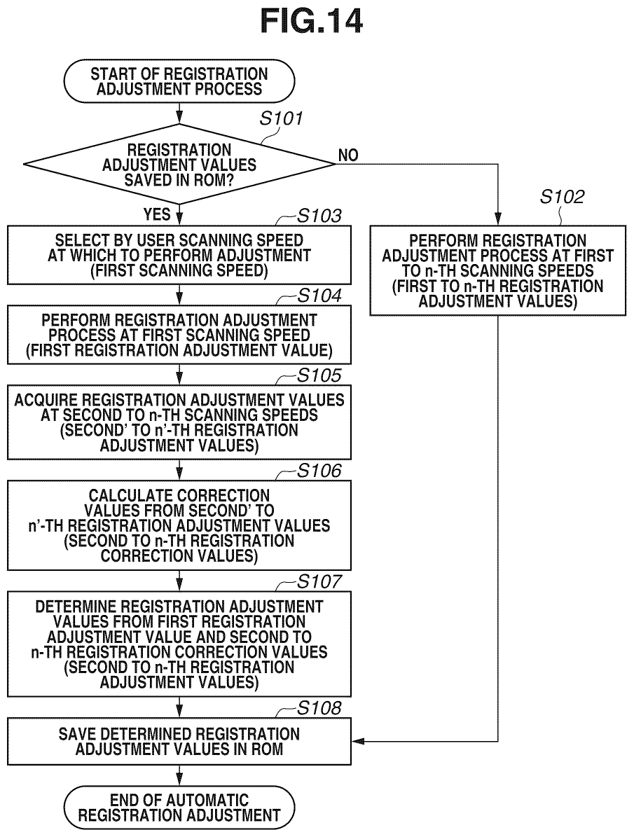

The registration adjustment process will now be described in detail. In the present exemplary embodiment, the registration adjustment process is performed at a scanning speed alone selected by the user (hereinafter, referred to as the first scanning speed). For the scanning speeds at which the registration adjustment process is not performed, corrections are made using the previous registration adjustment values stored in the ROM 52. In the registration adjustment process of the present exemplary embodiment, in order to adjust the dot recording positions for the forward scan and the backward scan, a reference pattern is recorded at the forward scan, and a shifted pattern is recorded at the backward scan. FIG. 14 illustrates an operation procedure in which the user performs the registration adjustment process in the inkjet recording apparatus of the present exemplary embodiment via the host device 10 or the I/F 11.

FIG. 14 illustrates an operation procedure for determining registration adjustment values at all scanning speeds (referred to as first to n-th scanning speeds, where n is an integer of 2 or more) used in the recording operation of the inkjet recording apparatus in the present exemplary embodiment, and storing the determined registration adjustment values in the ROM 52. This process is executed by the MPU 51. When the user selects and starts a registration adjustment process, first, in step S101, the MPU 51 as a determination unit determines whether registration adjustment values (first' to n′-th registration adjustment values) determined from the previous registration adjustment process are stored in the ROM 52. Thereafter, the MPU 51 determines whether the registration adjustment values are stored in the ROM 52. If the registration adjustment values are not stored (NO in step S101), the process proceeds to step S102. In step S102, the MPU 51 performs the registration adjustment processing at all scanning speeds to determine the registration adjustment values (first to n-th registration adjustment values) at the scanning speeds. If the MPU 51 determines in step S101 that the registration adjustment values are stored in the ROM 52 (YES in step S101), the process proceeds to step S103. In step S103, the user selects one scanning speed at which to perform adjustment. The scanning speed selected here is set as the first scanning speed.

In step S104, the registration adjustment process is performed at the first scanning speed to determine the registration adjustment values at the first scanning speed (first registration adjustment values). For unselected second to n-th registration adjustment values, in step S105, the MPU 51 acquires second' to n′-th registration adjustment values stored in the ROM 52. When the registration adjustment processing has been performed a plurality of times and a plurality of the second' to n′-th registration adjustment values are stored in the ROM 52, the most recent ones, i.e., the registration adjustment values determined in the previous registration adjustment process are desirably acquired. In step S106, the MPU 51 calculates second to n-th registration correction values.

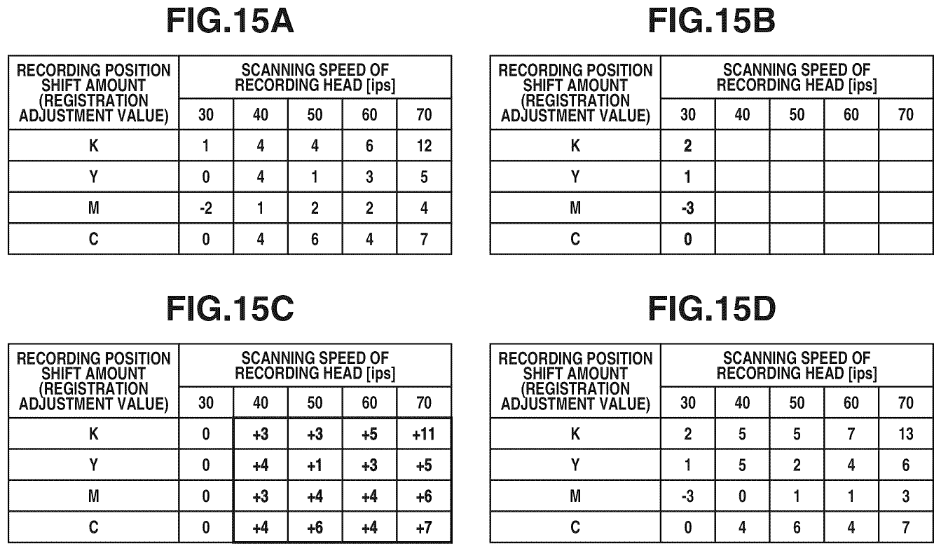

A specific calculation method will be described with reference to tables in FIGS. 15A to 15D. FIGS. 15A to 15D are tables illustrating the first to n-th scanning speeds and the registration adjustment values for individual colors stored in the ROM. FIG. 15A illustrates the first' to n′-th registration adjustment values stored in the ROM 52 at the time of performing the registration adjustment process. FIG. 15B illustrates the first registration adjustment values determined by the registration adjustment process in step S104 at the first scanning speed (30 inches/second in FIG. 15B) set by the user in step S103. FIG. 15C illustrates the differences of registration adjustment values for the individual colors at 40 to 70 inches/second from the registration adjustment values illustrated in FIG. 15A, with reference to registration adjustment values for the individual colors at 30 inches/second, which is the same as the first' scanning speed. These difference values are used as the second to n-th registration correction values in step S106.

In step S107, the MPU 51 adds the second to n-th registration correction values (corresponding to FIG. 15C) calculated in step S107 to the first registration adjustment values (corresponding to FIG. 15B) determined in step S104, and determines the result as the first to n-th registration adjustment values in FIG. 15D. In step S108, the finally determined registration adjustment values are stored in the ROM 52. In this manner, using the relationship in registration adjustment value between the scanning speeds makes it possible to perform adjustments with high accuracy in a short time without performing the registration adjustment processing at all scanning speeds.

As described above, if adjustment values are not stored in the ROM 52, the ejection timing adjustment is performed at n different scanning speeds. On the other hand, adjustment values are stored in the ROM 52, the ejection timing adjustment is performed at n-1 or fewer scanning speeds. For the scanning speeds where the ejection timing adjustment has not been performed, the correction values calculated by the MPU 51 based on the first registration adjustment values are used. This allows the registration adjustment process to be completed quickly without performing the registration adjustment processing for all scanning speeds.

In the present exemplary embodiment, the user desirably sets the first scanning speed, but the method of determining the first scanning speed is not limited to that. For example, in many inkjet recording apparatuses, the use of recorded products varies depending on the user. Inkjet recording apparatuses used in offices record a lot of documents and computer-aided design (CAD) drawings. To achieve high productivity for such outputs, the scanning speed of the recording head is often set to be high. On the other hand, for recording advertisements or photos, the scanning speed of the recording head is often set to be lower to achieve higher quality of recorded outputs. In this manner, when an inkjet recording apparatus is used under a specific recording condition, the number of times the recording condition is used is stored in the ROM 52, and the data is referred during the registration adjustment process. Setting the scanning speed of the most frequently used recoding condition stored in the ROM 52 as the first scanning speed allows the registration adjustment process to be performed for the frequently used recording condition to determine high-accuracy registration adjustment values, while also enabling quick determination of registration adjustment values for other less frequently used recording conditions without setting the first scanning speed by the user.

In the present exemplary embodiment, the dot recording positions are adjusted during forward and backward scanning. However, this is not limited to the adjustment, and can also be used in adjusting the dot recording positions between different ink colors or between different nozzle arrays.

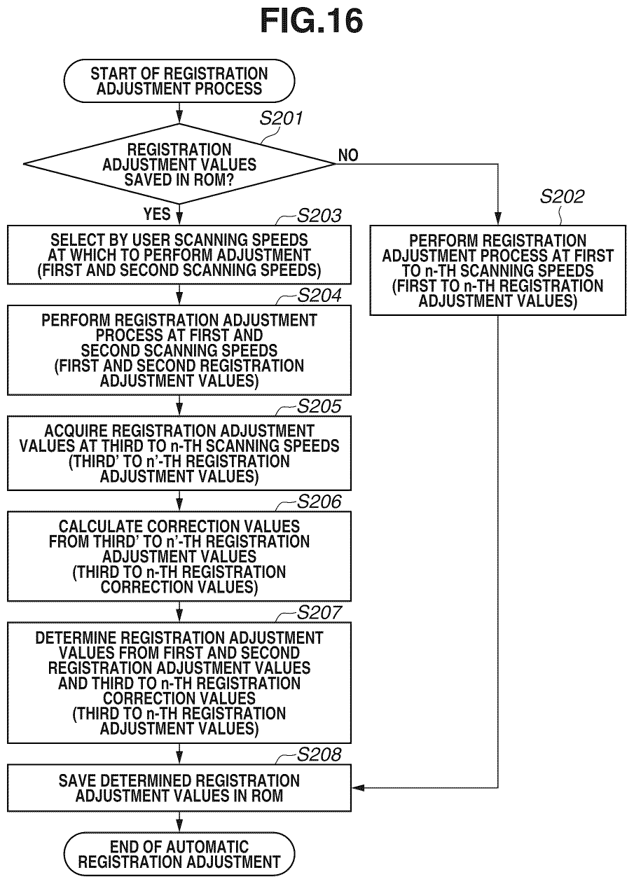

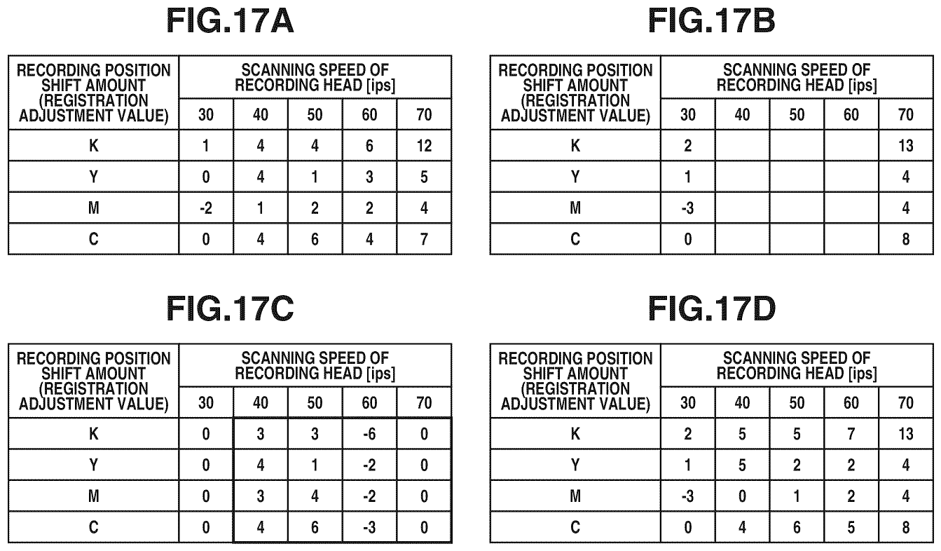

A second exemplary embodiment will now be described. In the second exemplary embodiment, the registration adjustment process is performed at a plurality of scanning speeds. This makes it possible to determine registration adjustment values at the scanning speeds with higher accuracy as compared with the case in the first exemplary embodiment. FIG. 16 illustrates a specific operation procedure, and FIGS. 17A to 17D illustrate adjusted, acquired, and calculated registration adjustment values in the tables. First, as in the first exemplary embodiment, in step S201, an MPU 51 determines whether previous registration adjustment values are stored in a ROM 52. If the previous registration adjustment values are not stored (NO in step S201), the process proceeds to step S202. If the previous registration adjustment values are stored in the ROM 52 as illustrated in FIG. 17A (YES in step S201), the process proceeds to step S203. In step S203, the user selects a scanning speed/scanning speeds at which the registration adjustment is to be performed. In the present exemplary embodiment, a first scanning speed (30 inches/second) and a second scanning speed (70 inches/second) are selected. The number of scanning speeds selected here can be any number as long as the number is equal to or less than n. The more scanning speeds selected, the longer the registration adjustment process will take, but that will allow more accurate adjustments. In step S204, the registration adjustment processes are performed at the first and second scanning speeds selected in step S203 to determine first registration adjustment values and second registration adjustment values. In step S205, as illustrated in FIG. 17B, the MPU 51 obtains third' to n-th' registration adjustment values from the ROM 52, and determines the differences between the registration adjustment values at the scanning speeds of 30 inch/sec and 70 inch/sec selected by the user in step S203 and the registration adjustment values at 40 inch/sec, 50 inch/sec, and 60 inch/sec. In the present exemplary embodiment, the differences between the registration adjustment values at similar scanning speeds are calculated. The differences between the registration adjustment values at 40 inch/sec and the registration adjustment values at 30 inch/sec are calculated, and the differences between the registration adjustment values at 60 inch/sec and the registration adjustment values at 70 inch/sec are calculated. The differences between the registration adjustment values at 50 inch/sec, which is an intermediate scanning speed, and the registration adjustment values at 30 inch/sec are calculated. This makes it possible to acquire the registration correction values at each scanning speed. In step S207, as illustrated in FIG. 17C, the MPU 51 reflects the registration adjustment values at 30 inches/sec and 70 inches/sec subjected to the registration adjustment process as is, and calculates the registration adjustment values at the remaining scanning speeds by adding the registration correction values calculated in step S206 to the above registration adjustment values. The MPU 51 adds the registration correction values at 40 inches/sec and 50 inches/sec to the registration adjustment values at 30 inches/sec, and adds the registration correction values at 60 inches/sec to the registration adjustment values at 70 inches/sec. In step S208, as illustrated in FIG. 17D, the MPU 51 stores the determined registration adjustment values at each scanning speed in the ROM 52.

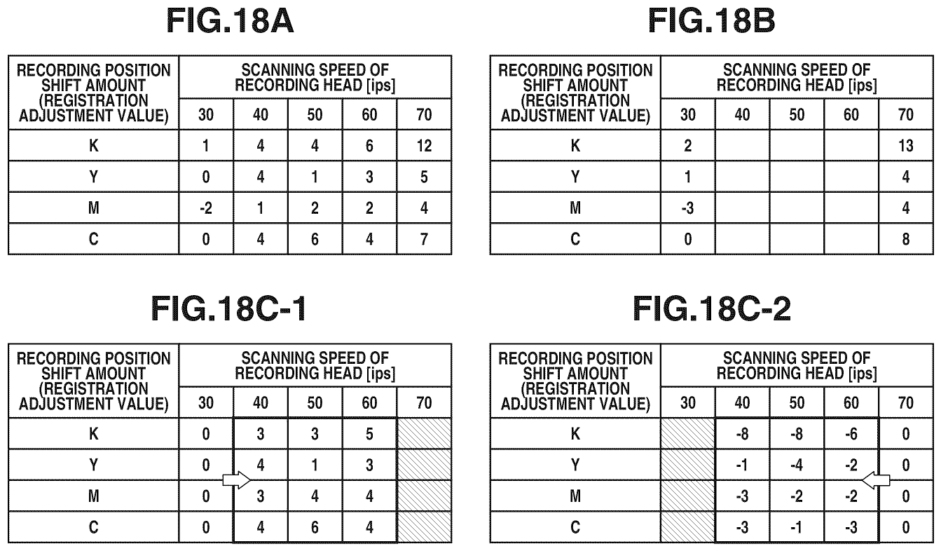

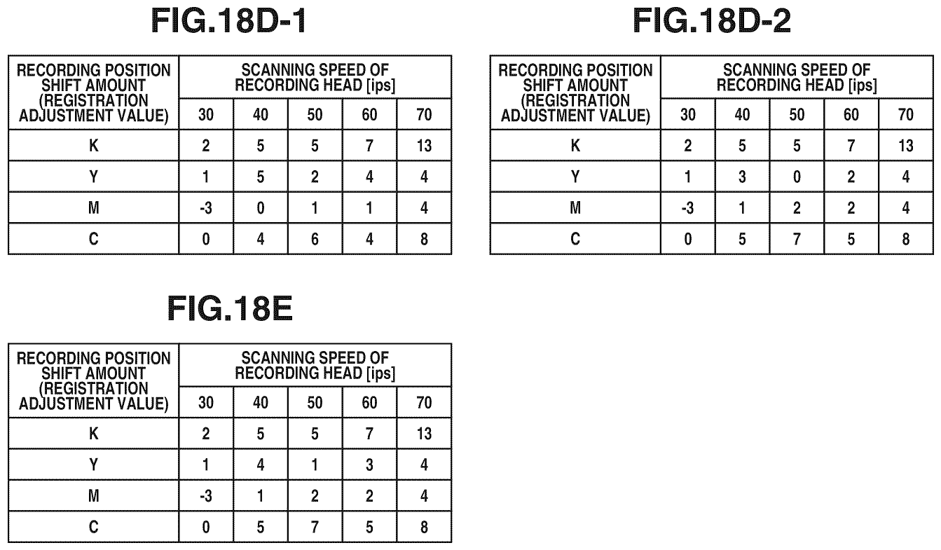

In the present exemplary embodiment, registration correction values are calculated from the differences between registration adjustment values at similar scanning speeds, but the calculation method for registration correction values is not limited to that. For example, even if the registration adjustment process is performed at a plurality of scanning speeds, registration correction values can be calculated using the differences from the first scanning speed alone or the second scanning speed alone. Registration correction values can be calculated by linear interpolation of scanning speeds and registration adjustment values. Furthermore, as illustrated in FIGS. 18A to 18E, the differences from the first scanning speed of 30 inches/second are obtained and used as registration correction values (FIG. 18C-1), which are then added to the first registration adjustment values determined by performing the registration adjustment process (FIG. 18D-1). Similarly, the differences from the second scanning speed of 70 inches/second are obtained and used as registration correction values (FIG. 18C-2), which are then added to the second registration adjustment values determined by performing the registration adjustment process (FIG. 18D-2). The calculations in these steps are performed separately, and those are then averaged to calculate the registration adjustment values (FIG. 18E).

As described above, a plurality of scanning speeds at which to perform the registration adjustment process increases the time for the registration adjustment process as compared with the case in the first exemplary embodiment, but enables registration adjustment with higher accuracy.

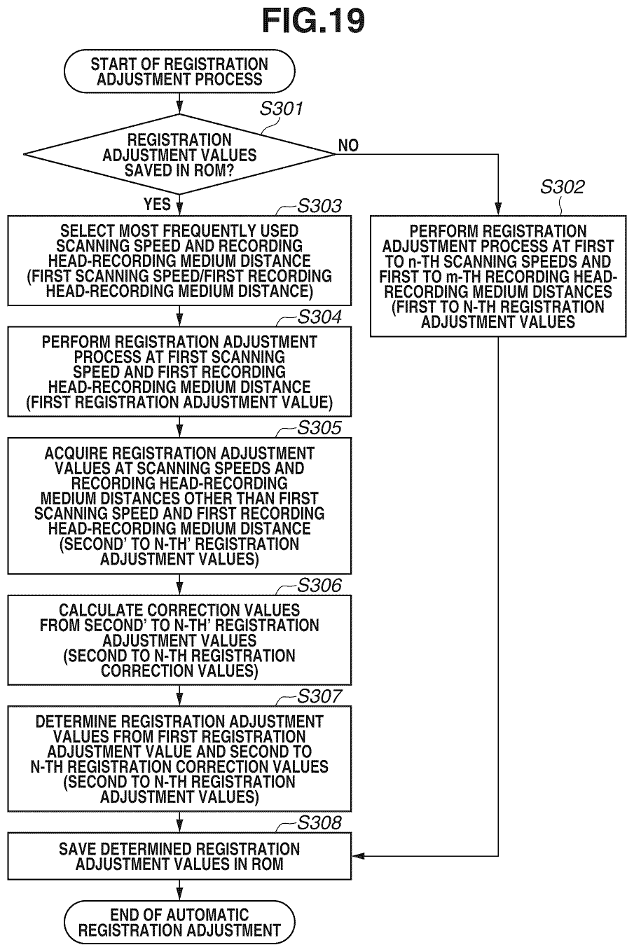

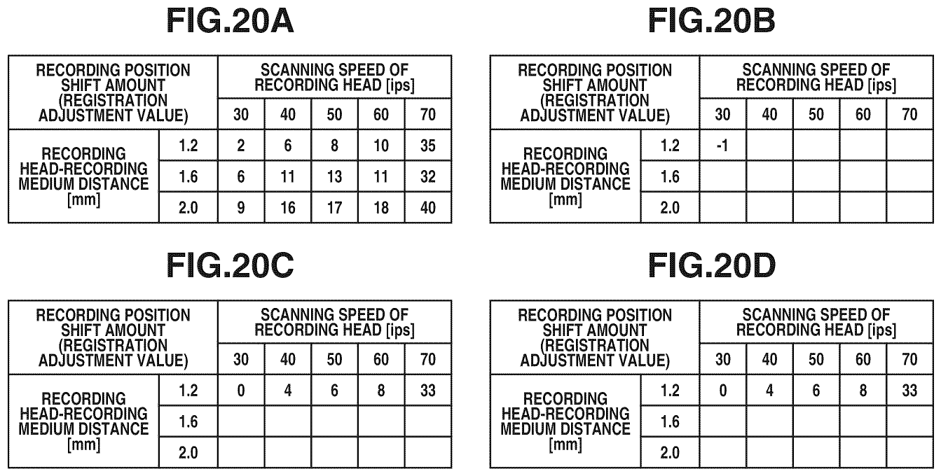

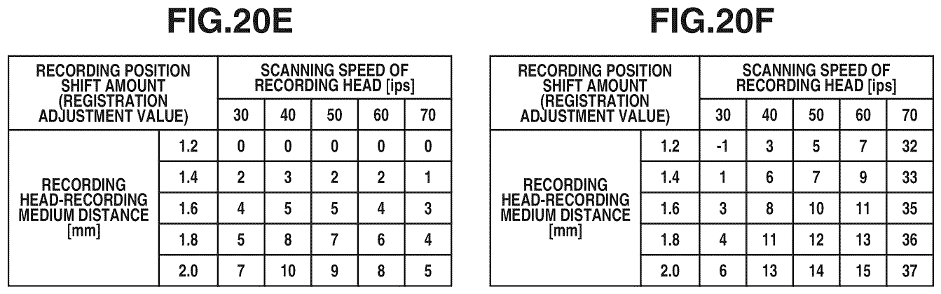

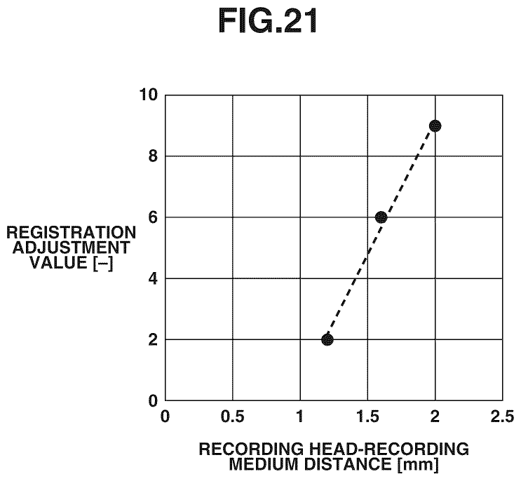

A third exemplary embodiment will now be described. In the third exemplary embodiment, a method will be described of calculating registration correction values for scanning speeds where no registration adjustment process is performed, as well as for a recording head-recording medium distance. FIG. 19 illustrates an operation procedure. In step S301 in FIG. 19, an MPU 51 determines whether previous registration adjustment values (first' to N-th' adjustment values) are stored in a ROM 52. In the present exemplary embodiment, first' to N-th' (N′=n′33 m′) registration adjustment values at first' to m-th' recording head-recording medium distances, as well as at first to n-th scanning speeds, are stored. FIG. 20A illustrates the registration adjustment values. The registration adjustment values in FIG. 20A to 20F are obtained by adjusting dot recording positions of cyan (C) in the forward direction and the backward direction. If it is determined that no registration adjustment values are stored in the ROM 52 (NO in step S301), the process proceeds to step S302. In step S302, the registration adjustment process is performed at first to n-th scanning speeds and first to m-th (m ways) recording head-recording medium distances, and determines the first to N-th registration adjustment values. If it is determined in step S301 that registration adjustment values are stored in the ROM 52 (YES in step S301), the process proceeds to step S303. In step S303, the scanning speed and recording head-recording medium distance used most frequently in the previous recording operations are selected as the first scanning speed and the first recording head-recording medium distance. In the present exemplary embodiment, the first scanning speed is 30 inches/second, and the first recording head-recording medium distance is 1.2 mm. As in the description of the first and second exemplary embodiments, the user can select the speed and distance in step S303. In step S304, the registration adjustment process is performed at the first scanning speed and the first recording head-recording medium distance selected in step S303, and determines the first registration adjustment value. In step S305, as illustrated in FIG. 20B, the registration adjustment values are acquired at the scanning speeds and recording head-recording medium distances other than the first scanning speed and the first recording head-recording medium distance to set as second' to N-th' registration adjustment values. In step S306, the MPU 51 calculates second to N-th registration correction values. As described in FIG. 20C, the registration correction values at scanning speeds of 40 in/sec, 50 in/sec, 60 in/sec, and 70 in/sec at the first recording head-recording medium distance of 1.2 mm are calculated by the above-described method in the first exemplary embodiment. As illustrated in FIG. 20D, the registration correction values at recording head-recording medium distances of 1.4 mm, 1.6 mm, 1.8 mm, and 2.0 mm are calculated with reference to the first' to N-th' registration adjustment values, using linear interpolations of changes in the registration adjustment values at the recording head-recording medium distances at the scanning speeds of the recording head. FIG. 21 is a graph representing a relationship between the recording head-recording medium distances and the first' to N-th' registration adjustment values at 30 inches/second. The recording head-recording medium distances and the registration adjustment values can be predicted linearly from the slope. From this relationship, the registration correction values (second to N-th registration correction values) for the second to m-th (m-1 ways) recording head-recording medium distances can be calculated at the scanning speeds based on the first recording head-recording medium distance as a reference. FIG. 20E illustrates the second to N-th registration correction values. In step S307, the MPU 51 adds the registration adjustment values at the first scanning speed determined in step S304 and the registration correction values calculated in step S306 to calculate the first to N-th registration adjustment values as illustrated in FIG. 20F. In step S308, the calculated registration adjustment values are stored in the ROM 52. In the present exemplary embodiment, one condition alone for the recording head-recording medium distance is set for performing the registration adjustment process. However, as a plurality of scanning speeds is set in the second exemplary embodiment, a plurality of recording head-recording medium distances can be set. This makes it possible to determine registration adjustment values with higher accuracy.

As described above, using previous registration adjustment values stored in the ROM 52 to calculate correction values for recording head-recording medium distances, as well as for scanning speeds, makes it possible to predict registration adjustment values with high accuracy. This significantly reduces the time for the registration adjustment process.

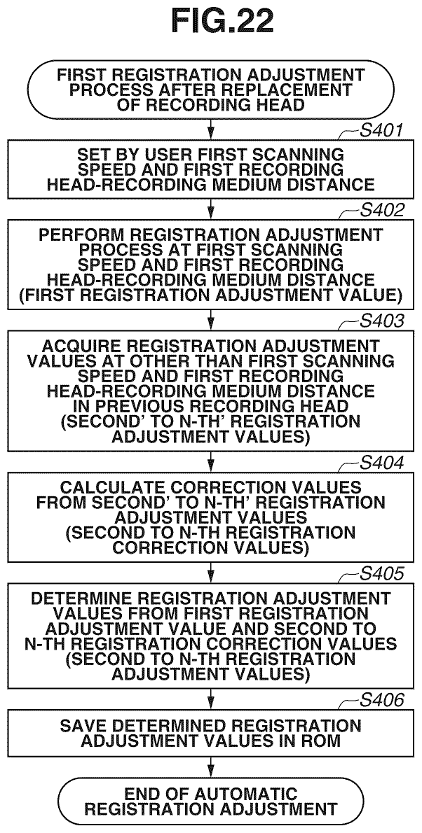

A fourth exemplary embodiment will now be described. As described with reference to FIGS. 13A to 13D, the above-described exemplary embodiment is also effective for correcting the registration adjustment values between different recording heads. In the present exemplary embodiment, the registration adjustment process after replacing a recording head used for a long time will be described in detail. In most conventional inkjet recording apparatuses, when a recording head is replaced, a registration adjustment process is performed. In this case, the registration adjustment process is performed at individual scanning speeds of the recording head and respective recording head-recording medium distances to determine registration adjustment values. In the present exemplary embodiment, as in the first to third exemplary embodiments, the registration adjustment process is performed at some scanning speeds and recording head-recording medium distances to determine registration adjustment values, while for other recording conditions, the registration correction values are used to determine registration adjustment values. FIG. 22 illustrates a procedure of a specific operation. During execution of the first registration adjustment process after replacement of the recording head, in step S401, the user sets the first scanning speed and the first recording head-recording medium distance at which to perform the registration adjustment process. In step S401, as in the third exemplary embodiment, the scanning speed and the distance may be automatically set from the number of times the recording conditions saved in a ROM 52 have been used, and pluralities of scanning speeds and recording head-recording medium distances may be set. In step S402, the registration adjustment process is performed at the first scanning speed and the first recording head-recording medium distance to determine a first registration adjustment value. In step S403, the registration adjustment values (second' to N-th' registration adjustment values) are acquired under recording conditions other than the first scanning speed and the first recording head-recording medium distance, using the registration adjustment values from the ROM 52 determined by the registration adjustment process with the recording head before replacement (hereinafter also referred to as a previous recording head). If the registration adjustment process has been performed a plurality of times with the previous recording head and a plurality of registration adjustment values is stored in the ROM 52, the oldest stored registration adjustment values, i.e., the registration adjustment values determined by the registration adjustment process first performed with the previous recording head. This is because the impact of changes in the ink ejection speed along with the long-term use of the recording head can be reduced. Using the oldest registration adjustment value enables the registration adjustment value to be inherited without any changes in durability of both the previous recording head and the replacement recording head, providing high adjustment accuracy. In step S404, the second to N-th registration correction values are calculated from the acquired second' to N-th' registration adjustment values. The method of calculating the registration correction values is described in the third exemplary embodiment. The second to N-th registration adjustment values are calculated based on the calculated second to N-th registration correction values and the first registration adjustment value determined in step S402. In step S406, the calculated second to N-th registration adjustment values are stored in the ROM 52.

As described above, even after replacement of the recording head, the registration correction values are calculated by using the registration adjustment values of the previous recording head stored in the ROM 52. This significantly reduces the time for the registration adjustment process after replacement of the recording head.

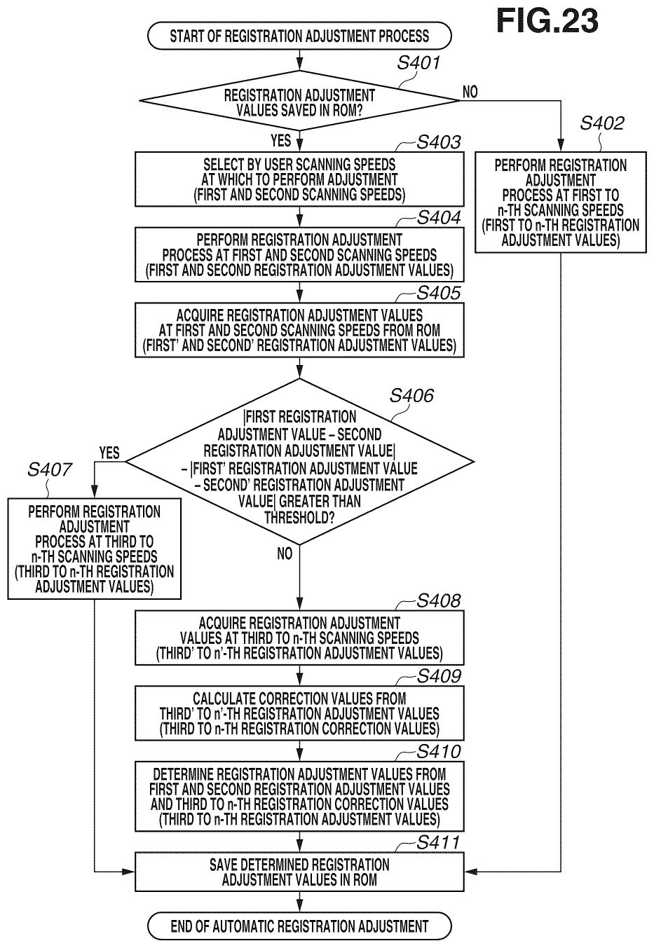

A fifth exemplary embodiment will now be described. In the present exemplary embodiment, the registration adjustment values at a plurality of scanning speeds are compared with those at the same scanning speeds stored in a ROM 52. If the differences between these values exceed a predetermined value, the registration adjustment process is performed at all scanning speeds. If the differences are below the predetermined value, registration correction values are calculated to determine registration adjustment values by using the above-described methods in the first to fourth exemplary embodiments. FIG. 23 illustrates an operation procedure. As in the first to third exemplary embodiments, in step S401, an MPU 51 determines whether registration adjustment values determined in the previous registration adjustment process are stored in the ROM 52. If the registration adjustment values are not stored (NO in step S401), the process proceeds to step S402. In step S402, the registration adjustment process is performed at all scanning speeds to determine registration adjustment values. If it is determined that the registration adjustment values are stored (YES in step S401), the process proceeds to step S403. In step S403, the user selects desired scanning speeds. (The selected scanning speeds are set as first scanning speed and second scanning speed). In the present exemplary embodiment, the first scanning speed is 40 inches/second, and the second scanning speed is 60 inches/second. In step S404, the registration adjustment process is performed to determine the registration adjustment values at the first scanning speed and the second scanning speed.

In step S405, the MPU 51 acquires from the ROM 52 the registration adjustment values at 40 inches/sec and 60 inches/sec, which are the same scanning speeds as the first and second scanning speeds selected by the user in step S403 (first' registration adjustment value and second' registration adjustment value). In step S406, the MPU 51 calculates the difference between the first and second registration adjustment values determined in step S404 (|first registration adjustment value−second registration adjustment value), and compares the calculated value with the difference between the first' and second' registration adjustment values obtained in step S405 (|first' registration adjustment value−second' registration adjustment value|). As the result of the comparison, the MPU 51 determines whether the difference value between the two is equal or greater than a predetermined value. In the present exemplary embodiment, the predetermined value is five. The predetermined value can be determined by the adjustment resolution of the registration adjustment process in the inkjet recording apparatus, or can be set by the user based on the image quality with which to perform recording. If ∥first registration adjustment value−second registration adjustment value| −|first' registration adjustment value−second' registration adjustment value∥ is five or more (YES in step S406), the MPU 51 determines that change in dot recording positions will be large even at other scanning speeds, the process proceeds to step S407. In step S407, the MPU 51 performs the registration adjustment process at third to n-th scanning speeds to determine third to n-th registration adjustment values. On the other hand, if |first registration adjustment value−second registration adjustment value|−|first' registration adjustment value−second' registration adjustment value∥ is less than a predetermined value of 5 (NO in step S406), the MPU 51 determines that registration correction values with sufficiently high accuracy can be calculated. In step S408, the MPU 51 acquires third' to n-th' registration adjustment values. In step S409, the MPU 51 calculates third to n-th registration correction values. In step S410, the MPU 51 determines third to n-th registration adjustment values. The calculation and determination methods in these steps are the same as the above-described methods in the first to fourth exemplary embodiments. In step S411, the MPU 51 stores the determined first to n-th registration adjustment values in the ROM 52.

As described above, in the fifth exemplary embodiment, it is determined whether to perform the registration adjustment process at all scanning speeds and recording head-recording medium distances as appropriate by comparing the registration adjustment values determined by actually performing the registration adjustment process with the registration adjustment values stored in the ROM 52. This makes it possible to maintain highly accurate adjustment even if dot recording positions change significantly due to long-term use of the inkjet recording apparatus.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-086657, filed May 28, 2024, which is hereby incorporated by reference herein in its entirety.

What is claimed is:

1. An inkjet recording apparatus comprising:
a recording head including a plurality of nozzle arrays for ejecting ink;
a carriage configured to cause the recording head to perform scanning at least at two or more speeds;
a first adjustment unit configured to adjust an ejection timing of the ink from the recording head with reference to each of the scanning speeds of the carriage;
a data storage unit configured to store the adjusted ejection timings as adjustment values; and
a first correction value calculation unit configured to calculate a correction value with respect to each of the scanning speeds of the carriage using the adjustment values stored in the data storage unit,
wherein the first adjustment unit adjusts the ejection timings at n scanning speeds in a case where the first adjustment unit adjusts the ejection timings with the adjustment values unstored in the data storage unit, the first adjustment unit adjusts the ejection timings at n-1 or fewer scanning speeds in a case where the first adjustment unit adjusts the ejection timings with the adjustment values stored in the data storage unit, and the first correction value calculation unit uses the correction value calculated based on the adjustment value from the first adjustment unit for an adjustment value at a scanning speed at which an ejection timing is not adjusted.

2. The inkjet recording apparatus according to claim 1, wherein the scanning speeds at which the ejection timings are adjusted include a scanning speed that is most frequently used in a recording operation of the inkjet recording apparatus.

3. The inkjet recording apparatus according to claim 1, wherein each of the correction values calculated by the first correction value calculation unit is a difference between an adjustment value at a scanning speed at which an ejection timing is adjusted and the adjustment value at the scanning speed at which the ejection timing is not adjusted.

4. The inkjet recording apparatus according to claim 1, further comprising:
a second adjustment unit configured to adjust the ejection timing with respect to each of distances between the recording head and a recording medium; and
a second correction value calculation unit configured to calculate a correction value with respect to each of the distances between the recording head and the recording medium using the adjustment value stored in the data storage unit,
wherein the second adjustment unit adjusts the ejection timings at m distances between the recording head and the recording medium in a case where the second adjustment unit adjusts the ejection timings with the adjustment value unstored in the data storage unit, the second adjustment unit adjusts the ejection timings at m-1 or fewer distances between the recording head and the recording medium in a case where the second adjustment unit adjusts the ejection timings with the adjustment values stored in the data storage unit, and the correction values calculated by the second correction value calculation unit is used for an adjustment value at a distance between the recording head and the recording medium at which an ejection timing is not adjusted.

5. The inkjet recording apparatus according to claim 4, wherein the correction values calculated by the second correction value calculation unit are calculated based on a relationship of linear interpolation of the adjustment values with respect to the distances between the recording head and the recording medium.

6. The inkjet recording apparatus according to claim 4,
wherein the recording head is replaceable, and
wherein in a case where the ejection timings of the recording head after replacement are adjusted while the adjustment values of the ejection timings of the recording head before the replacement are stored in the data storage unit, the correction values calculated from the adjustment values of the recording head before the replacement stored in the data storage unit are used for the adjustment value at the scanning speed or the distance between the recording head and a recording medium at which the ejection timing is not adjusted.

7. The inkjet recording apparatus according to claim 6, wherein each of the correction values is, among adjustment values stored in the data storage unit, an adjustment value stored first for the ejection timings performed at a time of attachment of the recording head before the replacement.

8. The inkjet recording apparatus according to claim 1, further comprising a determination unit configured to, in a case where the ejection timings are adjusted with the adjustment values stored in the data storage unit, adjust the ejection timings at at least two or more scanning speeds or distances between the recording head and a recording medium, and determine whether an absolute value of a difference between A and B is equal to or greater than a predetermined value where A is a difference between two or more acquired adjustment values and B is a difference between the adjustment values at the same scanning speeds or distances between the recording head and the recording medium stored in the data storage unit,
wherein in a case where the determination unit determines that the absolute value is equal to or greater than the predetermined value, an ejection timing is adjusted at a scanning speed or distance between the recording head and the recording medium at which the ejection timing is not adjusted, and in a case where the determination unit determines that the absolute value is less than the predetermined value, the correction value calculated by the first or second correction value calculation unit are used for the adjustment value at the scanning speed or distance between the recording head and the recording medium at which the ejection timing is not adjusted.

9. An adjustment method of a recording position in a recording apparatus including a recording head including a plurality of nozzle arrays for ejecting ink, and a carriage configured to cause the recording head to perform scanning at least at two or more speeds, the adjustment method comprising:
adjusting an ejection timing of the ink from the recording head to each of the scanning speeds of the carriage;
storing the adjusted ejection timings as adjustment values; and
calculating a correction value for each of the scanning speeds of the carriage using the adjustment values stored in the data storage unit,
wherein the ejection timings are adjusted at n scanning speeds in the adjusting in a case where the ejection timings are adjusted in the adjusting with the adjustment values unstored in the data storage unit, the ejection timings are adjusted at n-1 or fewer scanning speeds in the adjusting in a case where the ejection timings are adjusted in the adjusting with the adjustment values stored in the data storage unit, and the correction values calculated in the calculating are used in the adjusting for an adjustment value at a scanning speed at which an ejection timing is not adjusted.
